(19) United States
(12) Patent Application Publication
(10) Pub. No.: US 2013/0147710 A1
(43) Pub. Date: Jun. 13, 2013

(54) DISPLACEMENT DETECTING APPARATUS AND DISPLACEMENT DETECTING METHOD

(71) Applicants: Ming-Tsan Kao, Hsin-Chu City (TW); Hsin-Chia Chen, Hsin-Chu City (TW); Yi-Hsien Ko, Hsin-Chu City (TW)

(72) Inventors: Ming-Tsan Kao, Hsin-Chu City (TW); Hsin-Chia Chen, Hsin-Chu City (TW); Yi-Hsien Ko, Hsin-Chu City (TW)

(21) Appl. No.: 13/553,773

(22) Filed: Jul. 19, 2012

(30) Foreign Application Priority Data
Dec. 12, 2011 (TW) 100145849

(51) Int. Cl. G01C 21/00; G06F 3/033

(52) U.S. Cl. 345/158; 250/206.1; 250/349

(57) ABSTRACT

A displacement detecting apparatus, comprising: a first detecting module, for detecting displacement for an object on a detecting surface of the displacement detecting apparatus to generate first location information, and for generating a first control signal according to the first location information; a second detecting module, for detecting a target, and for detecting second location information for the displacement detecting apparatus relative to the target, and for generating a second control signal according to the second location information; and a switch apparatus, for selectively outputting at least one of the first control signal and the second control signal.

### BACKGROUND OF THE INVENTION

1. Field of the Invention

The present invention relates to a displacement detecting apparatus and a displacement detecting method, and particularly relates to a displacement detecting apparatus and a displacement detecting method, which can detect object displacement on a detecting surface of the displacement detecting apparatus or displacement of the displacement detecting apparatus relative to an object.

2. Description of the Prior Art

For modern electronic apparatuses, a finger navigating module such as a touch panel of a note book is always utilized as a displacement detecting apparatus, which can detects the motion for a finger on a detecting surface of the finger navigating module to move a cursor on a display. However, the finger navigating module is limited to detect the displacement on a planar surface. If displacement in a 3D space is desired to be detected, other apparatuses are needed to do such action.

For example, if a user wants to play a gunning game on a display, another kind of displacement detecting apparatus is needed. Such kind of “camera pointing apparatus” is a directional locating apparatus, which includes a control circuit respectively coupled to a camera, a computing unit and a communicating interface. The communicating interface is coupled to a host. Also, filters are provided in front of the camera, and a plurality of luminating devices, which can be shot by the camera are provided on the screen of the image displaying apparatus. The camera can be utilized to shoot the screen when the user utilizes the camera pointing apparatus to operate the program executed by the host. Other light sources can be filtered besides the light emitted from the luminating devices, since filters are provided for the camera. Therefore, only the light sources from the luminating devices appear in the frames shot by the camera, then the coordinates for the aiming points of the camera in the frame are computed by the computing unit and are transmitted to the host. By this way, the host can control the cursor of the image displaying apparatus based on the coordinates.

However, these two kinds of displacement detecting apparatus are suitable for different kinds of actions. For example, if words are desired to be input via displacement tracking detecting or one command is desired to be selected from a plurality of commands on the screen, the above-mentioned finger navigating module is preferred for such actions. On the contrary, if a game needs fast pointer moving, the above-mentioned camera pointing apparatus is preferred.

### SUMMARY OF THE INVENTION

Therefore, one objective of the present invention is to provide a displacement detecting apparatus that can utilize both above-mentioned displacement detecting methods.

One embodiment of the present invention discloses a displacement detecting apparatus, comprising: a first detecting module, for detecting displacement for an object on a detecting surface of the displacement detecting apparatus to generate first location information, and for generating a first control signal according to the first location information; a second detecting module, for detecting a target, and for detecting second location information for the displacement detecting apparatus relative to the target, and for generating a second control signal according to the second location information; and a switch apparatus, for selectively outputting at least one of the first control signal and the second control signal.

Additionally, another embodiment of the present invention discloses a displacement detecting apparatus, comprising: a housing; a detecting surface, on the housing, wherein the displacement detecting apparatus correspondingly generates a first control signal according to first location information when an object moves on the detecting surface to generate the first location information; a detecting window, wherein the displacement detecting apparatus detects second location information for the displacement detecting apparatus relative to a target via the detecting window and generates a second control signal according to the second location information; and a signal transmitting interface, for selectively outputting at least one of the first control signal and the second control signal.

Additionally, another embodiment of the present invention discloses a displacement detecting method, comprising: detecting displacement for an object on a detecting surface of a displacement detecting apparatus to generate first location information, and for generating a first control signal according to the first location information; detecting second location information for the displacement detecting apparatus relative to the target, and for generating a second control signal according to the second location information; and selectively outputting at least one of the first control signal and the second control signal.

In view of above-mentioned embodiments, two kinds of displacement detecting apparatuses can be combined together, such that the convenience significantly increases and the space for storing the apparatuses decreases. Also, power consumption can decrease via selecting a suitable process for generating and outputting the signal.

These and other objectives of the present invention will no doubt become obvious to those of ordinary skills in the art after reading the following detailed description of the preferred embodiment that is illustrated in the various figures and drawings.

### BRIEF DESCRIPTION OF THE DRAWINGS

FIG. 1 and FIG. 2 are schematic diagrams illustrating how the displacement detecting apparatus according to one embodiment of the present invention operates.

FIG. 3 is a schematic diagram illustrating a displacement detecting apparatus according to one embodiment of the present invention.

FIG. 4 is a block diagram illustrating a displacement detecting apparatus according to one embodiment of the present invention.

FIG. 5-FIG. 7 are flow charts illustrating displacement detecting method according to embodiments of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

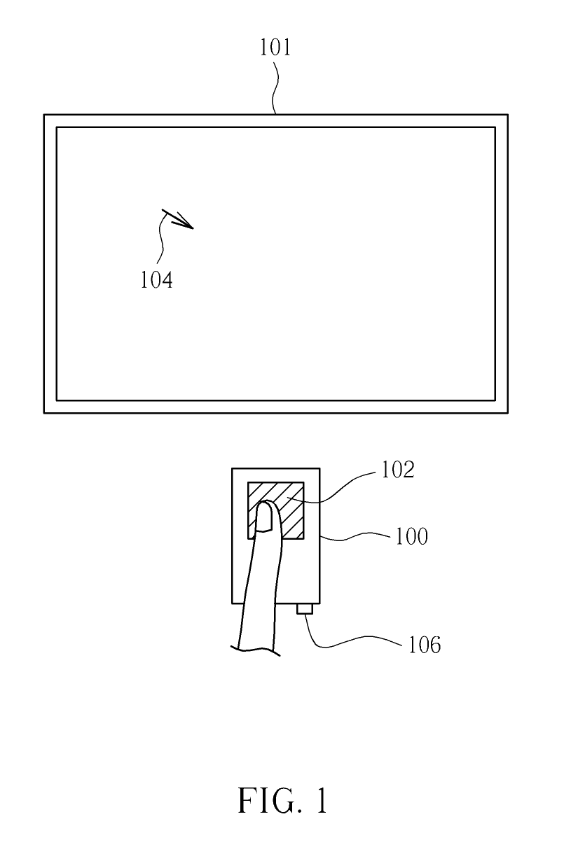

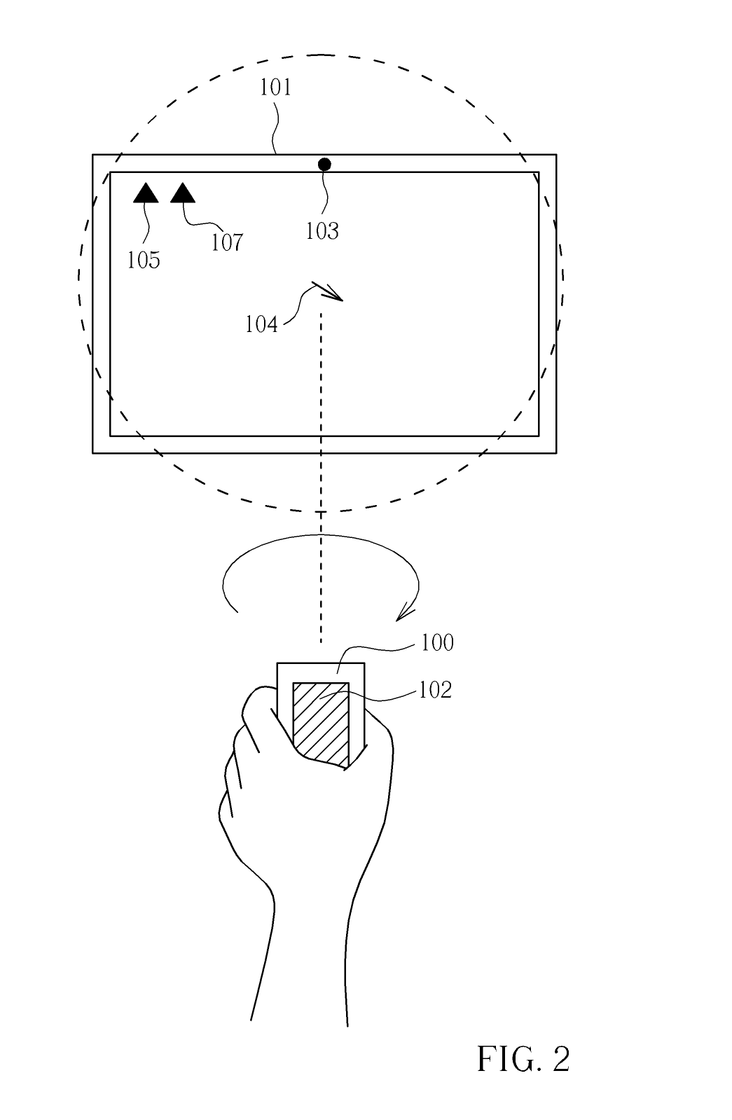

FIG. 1 and FIG. 2 are schematic diagrams illustrating how the displacement detecting apparatus 100 according to one embodiment of the present invention operates. As shown in FIG. 1 and FIG. 2, the displacement detecting apparatus 100 includes a detecting surface 102 for detecting first location information for an object, such as the finger in this embodiment, on the detecting surface 102 to generate a first control signal to control the movement of the cursor 104 on the display 101. In this case the displacement detecting apparatus 100 is a finger navigating apparatus, and the first location information is displacement amount for the object on the detecting surface 102.

Besides, as shown in FIG. 2, the displacement detecting apparatus 100 can be a directional locating apparatus if the user moves it via griping it. In this case, the detecting apparatus 100 outputs a second control signal according to second location information for the detecting apparatus 100 relative to another object (i.e. a target), to control the movement of the cursor 104 on the display 101. In one embodiment, a referring object 103 is provided on the display 101, such as a light source. For example, a light source arranged by at least one LED, or a light source uses preferably infrared light. Alternatively, a specific pattern on the corner of the display 101 but without affecting is playing for the display 101 can also be utilized as the referring object 103, for example, the triangular shape objects 105 and 107. The objects 103, 105, and 107 can be utilized for reference, such that the detecting apparatus 100 can output a second control signal to control the cursor 109 according to operation for itself relative to at least one of these referring objects. Therefore, the second location information can be the displacement for the detecting apparatus 100 relative to the display 101, or a directional coordinate for the detecting apparatus 100 on the display 101.

The displacement detecting apparatus 100 includes a switching apparatus, which can be utilized to output one of the first control signal and the second control signal, or to output both. The switching apparatus can be any kind of switching mechanism. For example, a hard ware switch 106 located on the displacement detecting apparatus 100 in one embodiment. Or, in another embodiment, a user can utilizes the first control signal or the second control signal of the displacement detecting apparatus 100 to control the cursor 104 for command switching. Also, in another embodiment, the displacement detecting apparatus 100 outputs the first control signal generated via sensing displacement for the object but does not output the second control signal when the object touches the detecting surface 102. Additionally, the displacement detecting apparatus 100 outputs the second control signal generated based on the displacement or location for displacement detecting apparatus 100 relative the target (ex. 103, 105, 107), but does not output the first control signal when the object does not touch the detecting surface 102.

The displacement detecting apparatus 100 can further be combined with other application programs to perform different functions besides moving the cursor as above-mentioned. In one embodiment, the first control signal and the second control signal can be simultaneously outputted. In this case, the first control signal and the second control signal can be utilized to call different functions if an user executes a game program. For example, the second control signal can be utilized to control moving directions for a role, and the first control signal can be utilized to control actions thereof.

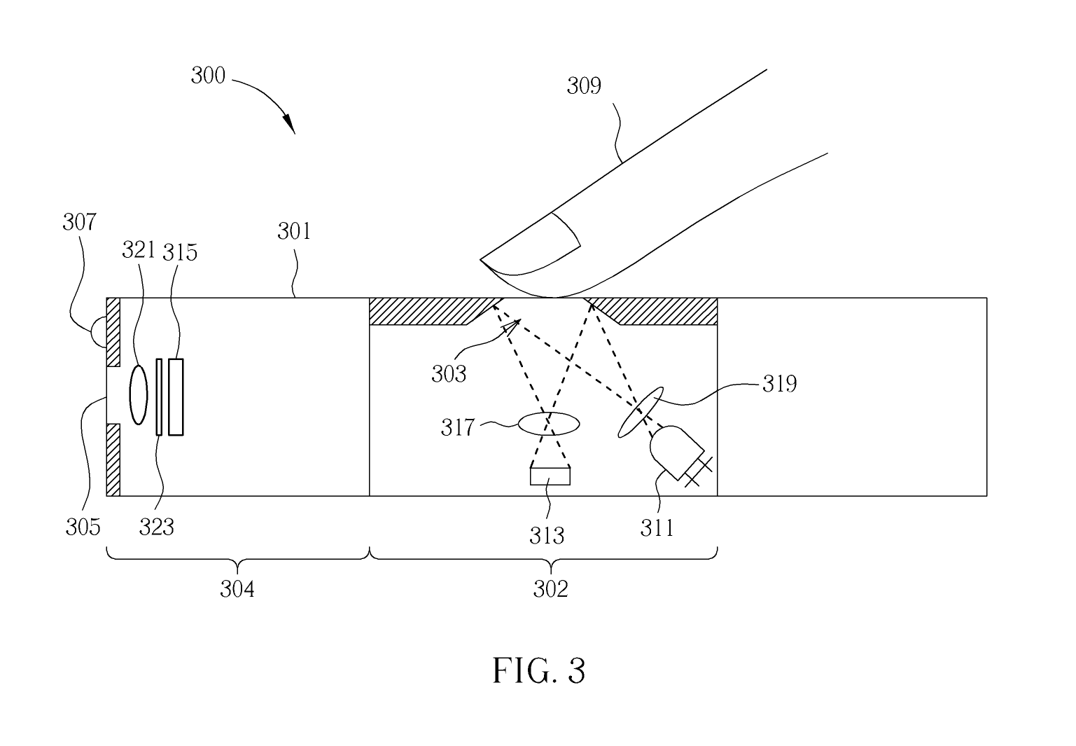

FIG. 3 is a schematic diagram illustrating a displacement detecting apparatus 300 according to one embodiment of the present invention. As shown in FIG. 3, the displacement detecting apparatus 300 includes: a housing 301, a detecting surface 303, a detecting window 305 and a signal transmitting interface 307. The detecting surface 303 is on the housing 301. The displacement detecting apparatus 300 correspondingly generates a first control signal, such as the operation shown in FIG. 1, according to first location information when an object 309 such as a finger moves on the detecting surface 303 to generate the first location information. The displacement detecting apparatus 300 detects second location information for the displacement detecting apparatus relative to a target via the detecting window 305 and generates a second control signal according to the second location information such as the operation shown in FIG. 2. The signal transmitting interface 307 selectively outputs at least one of the first control signal and the second control signal.

In one embodiment, an optical finger navigating module is utilized to generate a first control signal. In this embodiment, a light source 311 is provided under the detecting surface 303 to illuminate the object 309 to generate an image. The image detector 313 catches at least two frames of the image reflected by the object, and a processing unit (not illustrated in FIG. 3) to compute first location information. The image sensor 315 detects the above mentioned reference objects 103, 105 107 (the targets) and catches at least two frames of the images for these reference objects. After that, second location information is processed by a processing unit (not shown in FIG. 3).

The image sensor 315 can generate displacement for the image sensor 315 relative to the display 101 according to location variations for the reference objects 103, 105, 107 in the image, via catching continuous two frames. As the location relation between the reference objects 103, 105, 107 and the display 101 is known, the image sensor 315 can catch a frame and directly compute a directional coordinate according to location variations for the reference objects 103, 105, 107 in the image. The directional coordinate is a coordinate location for the image center of the image sensor 315 relative to the display 101. If the displacement detecting apparatus 300 is utilized as the cursor control apparatus as shown in FIG. 1 and FIG. 2, the processing unit computes first/second coordinates or variations of the first/second coordinates on the display according to the first/second location information, and outputs first/second coordinates or variations of the first/second coordinates as the first/second control signal. That is, the displacement detecting apparatus 300 includes a first detecting module 302 and a second detecting module 304. The first detecting module 302 is a finger navigating module in this embodiment, for sensing the operation for a finger on the displacement detecting apparatus 300 to generate the first control signal. The second detecting module 304 is a directional locating module in this embodiment, to generate the second control signal corresponding to the operations for which relative to reference objects. Besides above-mentioned devices, the displacement detecting apparatus 300 can further include lens 317, 319 and 321, and a infrared filter 323 to enhance the accuracy for computing the first location information and the second location information. The function of these lens and filters is well known by persons skilled in the art, thus it is omitted for brevity here.

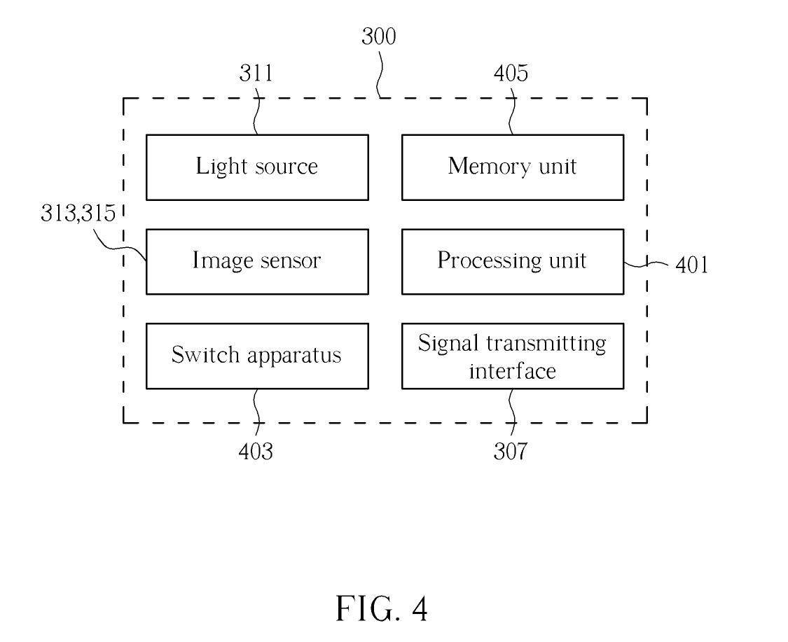

FIG. 4 is a block diagram illustrating the displacement detecting apparatus 300 according to one embodiment of the present invention. The displacement detecting apparatus 300 can further include a memory unit 405 besides above-mentioned signal transmitting interface 307, the light source 311, the image sensors 313, 315, the processing unit 401 and the switch device 403, to store data generated from the computing that the processor performs to the variations for the first/second coordinates. Alternatively, the memory unit 405 can also buffer frames for computing the first/second location information. It should be noted that, the images sensors 313, 315 can be independent hardware image sensors or a shared single hardware image sensor.

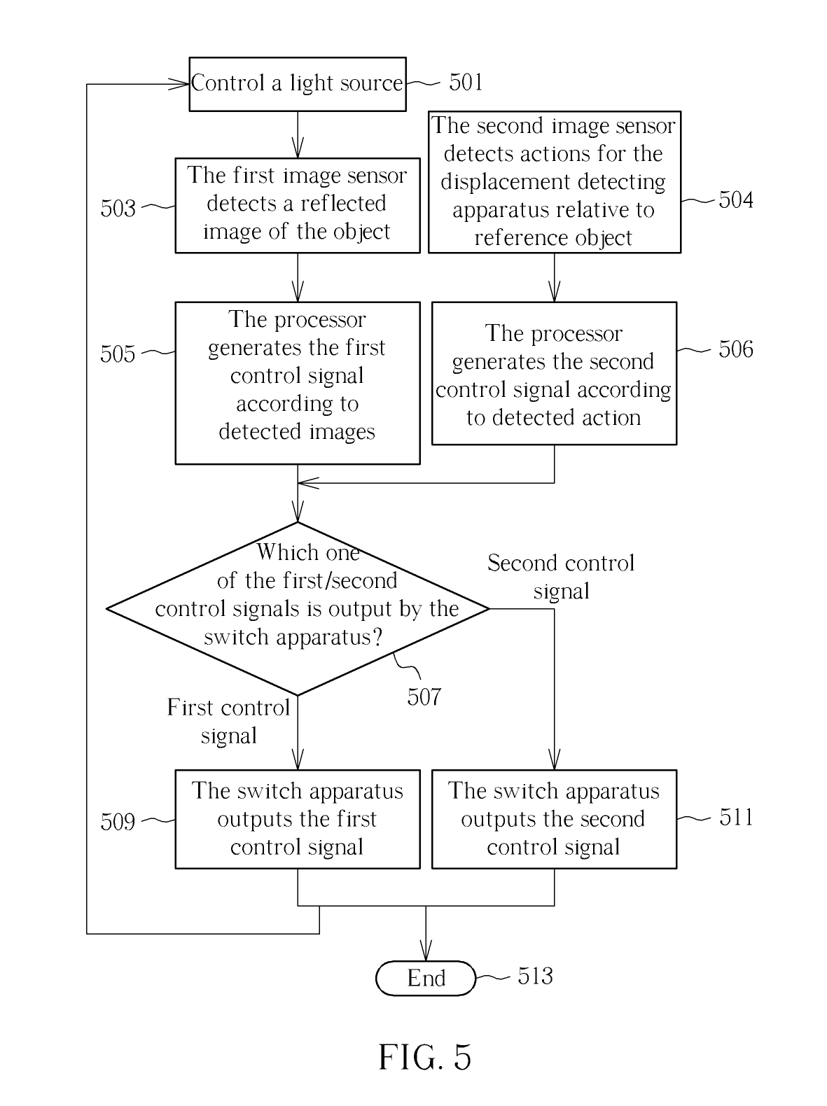

FIG. 5-FIG. 7 are flow charts illustrating displacement detecting method according to embodiments of the present invention.

The main concept for FIG. 5 is determining which one of the first/second control signals should be output after both of them are generated. FIG. 5 includes following steps:

Step 501

Control a light source such as the light source 311 in FIG. 3.

Step 503

The first image sensor, such as the image sensor 313 in FIG. 3, detects a reflected image of the object.

Step 504

The second image sensor, such as the image sensor 315 in FIG. 3, detects actions for the displacement detecting apparatus relative to reference object (target, such as 103, 105, 107 in FIG. 2).

Step 505

The processor generates the first control signal according to detected images. For example, motion estimation can be performed to detected images to generate the first control signal.

Step 506

The processor generates the second control signal according to detected action.

Step 507

Control the switch apparatus to output one of the first control signal and the second control signal.

Steps 509, 511

The switch apparatus to output the first control signal or the second control signal, and goes back the step 501 or the step 513 to accomplish the whole process.

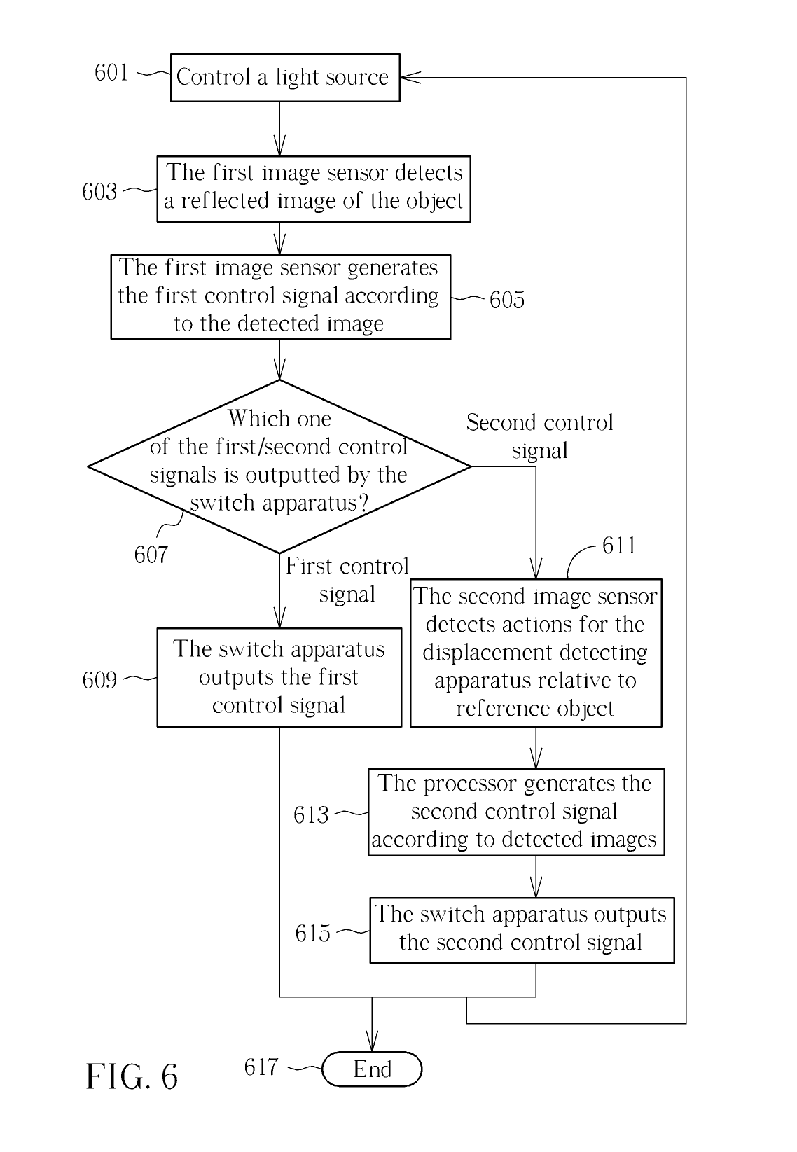

The main concept of FIG. 6 is determining which one of the first/second control signals should be output, after the first control signal is generated. If the first control signal is determined to be output, the first control signal is directly output. If the second control signal is determined to be output, the second control signal is generated to be output.

FIG. 6 includes following steps:

Step 601

Control a light source such as the light source 311 in FIG. 3.

Step 603

The first image sensor, such as the image sensor 313 in FIG. 3, detects a reflected image of the object.

Step 605

The first image sensor generates the first control signal according to the detected image.

Step 607

Control the switch apparatus to output one of the first control signal and the second control signal.

Step 609

The switch apparatus outputs the first control signal.

Step 611

The second image sensor detects actions for the displacement detecting apparatus relative to reference object

Step 613

The processor generates the second control signal according to detected images

Step 615

The switch apparatus outputs the second control signal.

After the steps 609 or 615, returning can be performed to go back to the step 601 or the step 617 to accomplish the whole process. It should be noted that orders for the group of steps 601, 603, 605, 609 and the group of steps 611, 613 and 615 can be exchanged. That is, the steps 611, 613 and 615 can be firstly performed such that the second control signal is generated. After that, enter the step 607 to determine which one of the first control signal and the second control signal is output, if the second control signal is desired to be output then directly output, otherwise perform steps 601, 603, 605 and 609 if the first control signal is desired to be output. Such equivalent variation should also fall in the scope of the present invention.

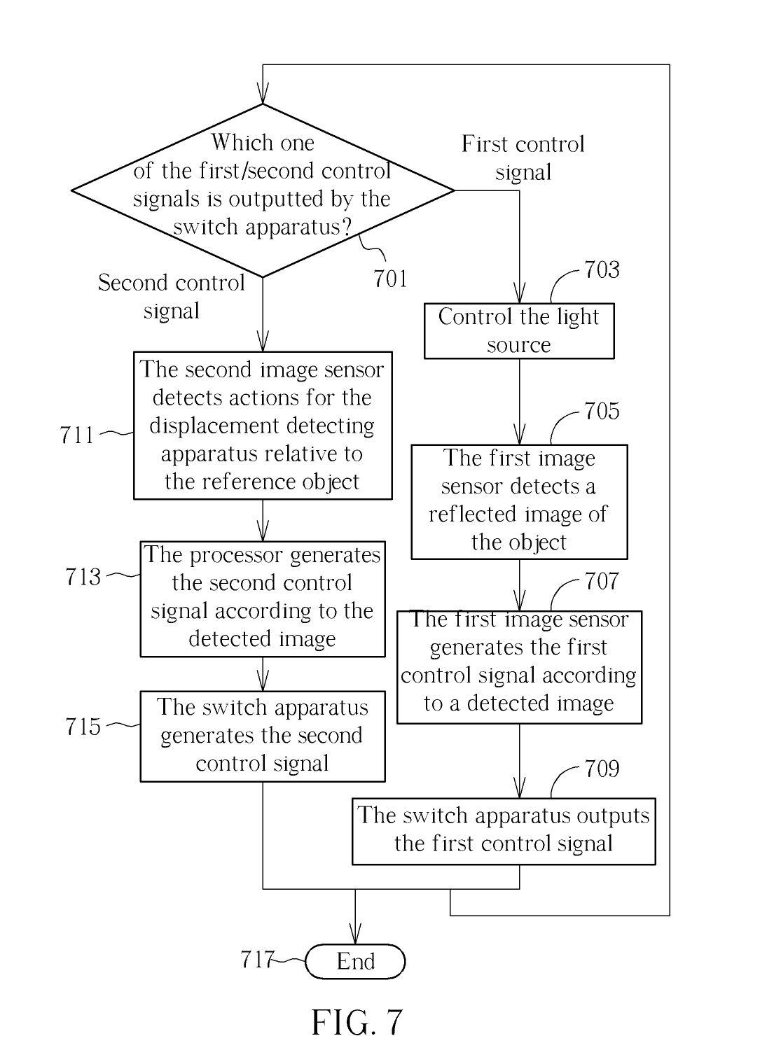

The main concept for FIG. 7 is that the first/second control signals are generated after determining which one is output. FIG. 7 includes the following steps:

Step 701

Control the switch apparatus to output one of the first control signal and the second control signal.

Step 703

Control the light source.

Step 705

The first image sensor detects a reflected image of the object.

Step 707

The first image sensor generates the first control signal according to a detected image.

Step 709

The switch apparatus outputs the first control signal.

Step 711

The second image sensor detects actions for the displacement detecting apparatus relative to reference object

Step 713

The processor generates the second control signal according to the detected image.

Step 715

The switch apparatus generates the second control signal.

After the steps 709 or 715, returning can be performed to go back to the step 701 or the step 717 to accomplish the whole process.

The user can selectively use one of the embodiments shown in FIG. 5 to FIG. 7, according to their habits or the situation. For example, if switching operation are supposed to be frequently performed between the first control signal and the second control signal, the embodiment shown in FIG. 5 should be utilized, which firstly generates both the first control signal and the second control signal such that they can be output in real time. However, if the frequency for utilizing the second control signal is supposed to be lower, the embodiment shown in FIG. 6 should be utilized, such that the power consumption can decrease.

In view of above-mentioned embodiments, the displacement detecting method according to one embodiment of the present invention can be summarized as follows: detecting displacement for an object on a detecting surface of a displacement detecting apparatus to generate first location information, and for generating a first control signal according to the first location information; detecting second location information for the displacement detecting apparatus relative to the target, and for generating a second control signal according to the second location information; and selectively outputting at least one of the first control signal and the second control signal.

It should be noted that the above-mentioned embodiment is only for example and do not mean to limit the scope of the present invention. The shapes and locations for each device in each diagram can not be considered as limitation for the present invention. Also, an image sensor is taken for example to explain the operations for detecting the displacement for one object on the displacement detecting apparatus, or the action that for the displacement detecting apparatus relative to the target, but other kind of sensors that can reach the same function should also fall in the scope of the present invention. For example, capacitance, resistance, electromagnet, ultrasonic, infrared or other kinds of sensors can also be utilized to detect displacement for the object on the detecting surface to generate the first control signal.

In view of above-mentioned embodiments, two kinds of displacement detecting apparatuses can be combined together, such that the convenience significantly increases and the space for storing the apparatuses decrease. Also, power consumption can decrease via selecting a suitable process for generating and outputting the signal.

Those skilled in the art will readily observe that numerous modifications and alterations of the apparatus and method may be made while retaining the teachings of the invention. Accordingly, the above disclosure should be construed as limited only by the metes and bounds of the appended claims.

What is claimed is:

1. A displacement detecting apparatus, comprising:
a first detecting module, for detecting displacement for an object on a detecting surface of the displacement detecting apparatus to generate first location information, and for generating a first control signal according to the first location information;
a second detecting module, for detecting a target, and for detecting second location information for the displacement detecting apparatus relative to the target, and for generating a second control signal according to the second location information; and
a switch apparatus, for selectively outputting at least one of the first control signal and the second control signal.

2. The displacement detecting apparatus of claim 1, wherein the first detecting module comprises:
a light source, for illuminating the object to generate an image; and
an image sensor, for catching at least two continuous frames of the image reflected by the object to compute the first location information.

3. The displacement detecting apparatus of claim 2, wherein the light source only illuminates the object when the switch apparatus selects the first control signal to be output.

4. The displacement detecting apparatus of claim 1, wherein the second detecting module comprises:
an image sensor, for sensing at least one infrared light source, and for computing location relation for the displacement detecting apparatus relative to the infrared light source.

5. The displacement detecting apparatus of claim 1, wherein the first location information is displacement amount for the object relative to the detecting surface.

6. The displacement detecting apparatus of claim 1, wherein the second location information is displacement amount for the target relative to the second detecting module or a directional coordinate generated by detecting operation that the second detecting module performs to the target.

7. The displacement detecting apparatus of claim 1, wherein the first detecting module is a finger navigating module.

8. The displacement detecting apparatus of claim 1, wherein the second detecting module is a directional locating module.

9. The displacement detecting apparatus of claim 1, wherein the switch apparatus outputs the first control signal but does not output the second control signal when the object touches the detecting surface, where the switch apparatus outputs the second control signal but does not output the first control signal when the object does not touch the detecting surface.

10. The displacement detecting apparatus of claim 9, wherein the second detecting module is turned off when the object touches the detecting surface.

11. The displacement detecting apparatus of claim 1, being a cursor control apparatus, for controlling a cursor on a display;
wherein the displacement detecting apparatus further includes a processing unit for computing a first coordinate or variation of the first coordinate for the cursor on the display according to the first location information;
where the processing unit is also for computing a second coordinate or variation of the second coordinate for the cursor on the display according to the second location information;
wherein the switch apparatus selectively outputs at least one of the variations of the first coordinate and the second coordinate.

12. The displacement detecting apparatus of claim 1, being a game control apparatus, wherein the first control signal and the second control signal are utilized to call different functions of a game program.

13. The displacement detecting apparatus of claim 1, wherein the switch apparatus selectively outputs at least one of the first control signal and the second control signal after the first detecting module generates the first control signal and the second detecting module generates the second control signal.

14. The displacement detecting apparatus of claim 1, wherein the first detecting module does not generate the first control signal if the object does not touch the detecting surface.

15. A displacement detecting apparatus, comprising:
a housing;
a detecting surface, on the housing, wherein the displacement detecting apparatus correspondingly generates a first control signal according to first location information when an object moves on the detecting surface to generate the first location information;
a detecting window, wherein the displacement detecting apparatus detects second location information for the displacement detecting apparatus relative to a target via the detecting window and generates a second control signal according to the second location information; and
a signal transmitting interface, for selectively outputting at least one of the first control signal and the second control signal.

16. The displacement detecting apparatus of claim 15, wherein a light source is provided under the detecting surface, for illuminating the object to generate an image, where the displacement detecting apparatus computes the first location information according to the image reflected by the object.

17. The displacement detecting apparatus of claim 16, wherein the light source only illuminates the object when the signal transmitting interface selects the first control signal to be output.

18. The displacement detecting apparatus of claim 15, wherein the first location information is displacement amount for the object relative to the detecting surface.

19. The displacement detecting apparatus of claim 15, wherein the second location information is displacement amount for the target relative to the second detecting module or a directional coordinate generated by detecting operation that the detecting window performs to the target.

20. The displacement detecting apparatus of claim 15, wherein the first control signal is generated via moving a finger on the detecting surface.

21. The displacement detecting apparatus of claim 15, wherein the signal transmitting interface outputs the first control signal but does not output the second control signal when the object touches the detecting surface, where the signal transmitting interface outputs the second control signal but does not output the first control signal when the object does not touch the detecting surface.

22. The displacement detecting apparatus of claim 15, being a cursor control apparatus, for controlling a cursor on a display;
wherein the displacement detecting apparatus computes a first coordinate or variation of the first coordinate for the cursor on the display according to the first location information;
where the displacement detecting apparatus also computes a second coordinate or variation of the second coordinate for the cursor on the display according to the second location information;
wherein the signal transmitting interface selectively outputs at least one of the variations of the first coordinate and the second coordinate.

23. The displacement detecting apparatus of claim 15, being a game control apparatus, wherein the first control signal and the second control signal are utilized to call different functions of a game program.

24. The displacement detecting apparatus of claim 15, wherein the signal transmitting interface selectively outputs at least one of the first control signal and the second control signal after the first control signal and the second control signal are generated.

25. The displacement detecting apparatus of claim 15, wherein the first control signal is not generated if the object does not touch the detecting surface.

26. A displacement detecting method, comprising:
detecting displacement for an object on a detecting surface of a displacement detecting apparatus to generate first location information, and for generating a first control signal according to the first location information;
detecting second location information for the displacement detecting apparatus relative to the target, and for generating a second control signal according to the second location information; and
selectively outputting at least one of the first control signal and the second control signal.

27. The displacement detecting method of claim 26, wherein the step of generating the first location information comprises:
illuminating the object to generate an image; and
catching at least two continuous frames of the image reflected by the object to compute the first location information.

28. The displacement detecting method of claim 27, wherein the step of illuminating the object only illuminates the object when the first control signal is selected to be output.

29. The displacement detecting method of claim. 26, wherein the first location information is displacement amount for the object relative to the detecting surface.

30. The displacement detecting method of claim 26, wherein the second location information is displacement amount for the target relative to the displacement detecting apparatus or a directional coordinate generated by detecting operation that the displacement detecting apparatus performs to the target.

31. The displacement detecting method of claim. 26, wherein the first control signal is generated via moving a finger on the detecting surface.

32. The displacement detecting method of claim 26, wherein the step of selectively outputting at least one of the first control signal and the second control signal outputs the first control signal but does not output the second control signal when the object touches the detecting surface, where the switch apparatus outputs the second control signal but does not output the first control signal when the object does not touch the detecting surface.

33. The displacement detecting method of claim 26, applied to a cursor control apparatus, for controlling a cursor on a display;
wherein the displacement detecting method further includes:
computing a first coordinate or variation of the first coordinate for the cursor on the display according to the first location information;
computing a second coordinate or variation of the second coordinate for the cursor on the display according to the second location information; and
selectively outputting at least one of the variations of the first coordinate and the second coordinate.

34. The displacement detecting method of claim 26, applied to a game control apparatus, wherein the first control signal and the second control signal are utilized to call different functions of a game program.

35. The displacement detecting method of claim 26, wherein in at least one of the first control signal and the second control signal is selectively output after both the first control signal and the second control signal are generated.

36. The displacement detecting method of claim 26, wherein the first control signal is not generated if the object does not touch the detecting surface.
